(19) United States
(12) Patent Application Publication
(10) Pub. No.: US 2024/0215576 A1
(43) Pub. Date: Jul. 4, 2024

(54) HEAT-RESISTANT MOLD GROWTH INHIBITOR, FOOD AND DRINK IN WHICH GROWTH OF HEAT-RESISTANT MOLD IS INHIBITED, AND METHOD FOR INHIBITING GROWTH OF HEAT-RESISTANT MOLD

(71) Applicant: NIPPON SHINYAKU CO., LTD., Minami-ku, Kyoto-shi, Kyoto (JP)

(72) Inventors: Hisato TAMIYA, Kyoto (JP); Kentaro TSUDA, Kyoto (JP)

(73) Assignee: NIPPON SHINYAKU CO., LTD., Minami-ku, Kyoto-shi, Kyoto (JP)

(21) Appl. No.: 18/684,158

(22) PCT Filed: Oct. 6, 2022
(86) PCT No.: PCT/JP2022/037389

§ 371 Date: Feb. 15, 2024

(30) Foreign Application Priority Data
Nov. 16, 2021 (JP) 2021-186541

(51) Int. Cl. A01N 37/06; A01P 3/00; A23L 2/44; A23L 3/3517

(52) U.S. Cl. CPC A01N 37/06; A01P 3/00; A23L 2/44; A23L 3/3517

(57) ABSTRACT

For providing a heat-resistant mold growth inhibitor capable of inhibiting growth of heat-resistant mold without performing heat treatment at a high temperature, food and drink in which the growth of heat-resistant mold is inhibited, and a method for inhibiting the growth of heat-resistant mold, the heat-resistant mold growth inhibitor according to the present disclosure contains diethyl fumarate and/or 2-decenoic acid as an active component.

### TECHNICAL FIELD

The present disclosure relates to a heat-resistant mold growth inhibitor capable of inhibiting growth of heat-resistant mold, and food and drink in which the growth of heat-resistant mold is inhibited, and a method for inhibiting the growth of heat-resistant mold using the heat-resistant mold growth inhibitor.

### BACKGROUND ART

Conventionally, food and drink which may be polluted with microorganisms or the like is usually subjected to heat treatment to sterilize the internal microorganisms or the like.

However, mold containing spores that are in a thick shell, such as an ascocarp, for example, has heat resistance to survive after being subjected to heat treatment for 10 minutes at 70° C. to 30 minutes at 75° C. (for example, see PTLs 1 and 2).

Thus, it is necessary to perform heat treatment at a higher temperature (for example, not less than 100° C.) in food and drink which may be polluted with such mold having heat resistance (hereinafter, may be referred to as “heat-resistant mold”) for inhibiting growth of the mold.

### RELATED ART DOCUMENT

### Patent Document

PTL 1: JP-A-2018-143147
PTL 2: JP-A-2021-141882

On the other hand, the heat treatment at a high temperature tends to change flavor, color tone, texture, nutritional components, and the like of food and drink, thus leading to quality deterioration. Therefore, it has been required to develop a method for inhibiting growth of heat-resistant mold other than the high-temperature heat treatment.

### SUMMARY

### Problems to be Solved by the Disclosure

The present disclosure provides a heat-resistant mold growth inhibitor capable of inhibiting growth of heat-resistant mold without performing heat treatment at a high temperature, food and drink in which the growth of heat-resistant mold is inhibited, and a method for inhibiting the growth of heat-resistant mold.

### Means for Solving the Problems

For achieving the above objects, the present disclosure provides the following aspects [I] to [X].
[I] A heat-resistant mold growth inhibitor containing diethyl fumarate and/or 2-decenoic acid as an active component.
[II] The heat-resistant mold growth inhibitor as recited in [I], wherein the heat-resistant mold survives under a heating condition at 70° C. for 10 minutes.
[III] The heat-resistant mold growth inhibitor as recited in [I] or [II], wherein the heat-resistant mold belongs to at least one of the genus Byssochlamys or the genus Neosartorya.
[IV] Food and drink in which growth of heat-resistant mold is inhibited, comprising the heat-resistant mold growth inhibitor as recited in any one of [I] to [III] such that a concentration of diethyl fumarate and/or 2-decenoic acid is 1 to 40000 ppm.
[V] The food and drink in which growth of heat-resistant mold is inhibited as recited in [IV], wherein the concentration of diethyl fumarate is 1 to 20000 ppm.
[VI] The food and drink in which growth of heat-resistant mold is inhibited as recited in [IV] or [V], wherein the concentration of 2-decenoic acid is 1 to 20000 ppm.
[VII] A method for inhibiting growth of heat-resistant mold in food and drink, the method including adding the heat-resistant mold growth inhibitor as recited in any one of [I] to [III] to the food and drink such that a concentration of diethyl fumarate and/or 2-decenoic acid is 1 to 40000 ppm.
[VIII] The method for inhibiting growth of heat-resistant mold as recited in [VII], wherein the heat-resistant mold growth inhibitor is added to the food and drink such that the concentration of diethyl fumarate is 1 to 20000 ppm.
[IX] The method for inhibiting growth of heat-resistant mold as recited in [VII] or [VIII], wherein the heat-resistant mold growth inhibitor is added to the food and drink such that the concentration of 2-decenoic acid is 1 to 20000 ppm.
[X] A method for inhibiting growth of heat-resistant mold in a target, including using the heat-resistant mold growth inhibitor as recited in any one of [I] to [III].

The present inventors had intensively investigated for obtaining a heat-resistant mold growth inhibitor capable of inhibiting the growth of heat-resistant mold without performing heat treatment at a high temperature. In the investigation, they found out that various components reported to have an effect of inhibiting growth of ordinary mold (non-heat-resistant mold) do not necessarily have a growth inhibition effect against heat-resistant mold.

The inventors have further investigated based on this finding, and as a result, they found that the growth of heat-resistant mold in food and drink can be effectively inhibited, without changing flavor, color tone, texture, nutritional components, and the like of the food and drink, by using a heat-resistant mold growth inhibitor containing diethyl fumarate and/or 2-decenoic acid as an active component. Thus, the present disclosure was completed.

### Effects of the Disclosure

The heat-resistant mold growth inhibitor of the present disclosure can inhibit the growth of heat-resistant mold without performing heat treatment at a high temperature.

### EMBODIMENTS OF THE DISCLOSURE

Hereinafter, the present disclosure will be described in more detail based on embodiments of the present disclosure. However, the present disclosure is not limited to these embodiments.

In the present disclosure, the expression “X to Y” (X and Y are given numbers), unless otherwise specified, encompasses the meanings of “not less than X and not greater than Y,” and “preferably greater than X” or “preferably less than Y.”

The expression “not less than X” (X is a given number) or “not greater than Y” (Y is a given number) encompasses the meaning of “preferably greater than X” or “preferably less than Y.”

Additionally, the expression “X and/or Y” (X and Y are given numbers) encompasses the meanings of “both X and Y,” and “only X” or “only Y.”

### Heat-Resistant Mold Growth Inhibitor

The heat-resistant mold growth inhibitor according to the present embodiment contains diethyl fumarate (diethyl (E)-but-2-enedioate) and/or 2-decenoic acid ((E)-dec-2-enoic acid) as an active component.

In the present disclosure, “active component” means a component capable of producing an effect of inhibiting growth of heat-resistant mold, which is the effect of the present disclosure. Even if a component having the effect of inhibiting growth of heat-resistant mold is contained in such a concentration that the effect cannot be obtained, that component is excluded.

Heat-resistant mold which is growth-inhibited by the above heat-resistant mold growth inhibitor refers to mold containing spores that are in a thick shell such as an ascocarp, and capable of surviving under a heating condition at 70° C. for 10 minutes, and more preferably, at 75° C. for 30 minutes. In the present embodiment, particularly among the heat-resistant mold, high growth inhibition effect can be obtained against mold belonging to the genus Byssochlamys and the genus Neosartorya.

Examples of the heat-resistant mold belonging to the genus Byssochlamys include Byssochlamys fulva (B. fulva), Byssochlamys nivea, and Byssochlamys lagunculariae. Examples of the heat-resistant mold belonging to the genus Neosartorya include Neosartorya primulina (N. primulina), Neosartorya fischeri, and Neosartorya glabra.

In the present embodiment, among these, a higher effect can be observed against B. fulva and N. primulina.

The heat-resistant mold growth inhibitor according to the present embodiment may be composed of only diethyl fumarate and/or 2-decenoic acid as an active component, or may be a composition containing a plurality of components other than these.

In the case where the heat-resistant mold growth inhibitor according to the present embodiment is a composition, examples of the components other than diethyl fumarate and/or 2-decenoic acid being the active component include various solvents, various excipients, or the like. These components may be used to prepare, for example, a spray agent in which diethyl fumarate and/or 2-decenoic acid being the active component is dissolved in a solvent such as ethanol, or powder in which the above active component is mixed with an excipient (e.g., gum arabic or dextrin), and the like.

The heat-resistant mold growth inhibitor is used in a target such that the concentration of diethyl fumarate and/or 2-decenoic acid is preferably 1 to 40000 ppm, more preferably 10 to 20000 ppm, still more preferably 20 to 10000 ppm, and further preferably 30 to 5000 ppm. Note that “ppm” represents mass ratio in the present disclosure.

Further, the heat-resistant mold growth inhibitor is used in a target such that the concentration of diethyl fumarate is preferably 1 to 20000 ppm, more preferably 10 to 10000 ppm, still more preferably 20 to 5000 ppm, and further preferably 30 to 2500 ppm.

Furthermore, the heat-resistant mold growth inhibitor is used in a target such that the concentration of 2-decenoic acid is preferably 1 to 20000 ppm, more preferably 10 to 10000 ppm, still more preferably 20 to 5000 ppm, and further preferably 30 to 2500 ppm.

### Method for Inhibiting Growth of Heat-Resistant Mold

The method for inhibiting the growth of heat-resistant mold according to the present embodiment is a method for inhibiting the growth of heat-resistant mold in a target using the above heat-resistant mold growth inhibitor.

In the present disclosure, “target” means an object itself in which the effect of inhibiting growth of heat-resistant mold is exerted, and examples thereof include food and drink such as beverages and groceries, soil, floor, wall, and house dust.

In the case where the target is food and drink, the growth of heat-resistant mold in the food and drink can be inhibited by adding the heat-resistant mold growth inhibitor to the food and drink. The heat-resistant mold growth inhibitor is added to the food and drink such that the concentration of diethyl fumarate and/or 2-decenoic acid is preferably 1 to 40000 ppm, more preferably 10 to 20000 ppm, still more preferably 20 to 10000 ppm, and further preferably 30 to 5000 ppm. Further, the heat-resistant mold growth inhibitor is added to the food and drink such that the concentration of diethyl fumarate is preferably 1 to 20000 ppm, more preferably 10 to 10000 ppm, still more preferably 20 to 5000 ppm, and further preferably 30 to 2500 ppm.

Furthermore, the heat-resistant mold growth inhibitor is added to the food and drink such that the concentration of 2-decenoic acid is preferably 1 to 20000 ppm, more preferably 10 to 10000 ppm, still more preferably 20 to 5000 ppm, and further preferably 30 to 2500 ppm.

The heat-resistant mold growth inhibitor may be added to the food and drink as it is. Alternatively, for example, the heat-resistant mold growth inhibitor may be dissolved in a solvent such as ethanol to prepare a solution, and then the solution may be added to the food and drink, or powder prepared by mixing the heat-resistant mold growth inhibitor with an excipient (e.g., gum arabic or dextrin) and the like may be added to the food and drink.

The food and drink may be in the form of, for example, liquid, solid, or jelly. From the view point that the concentration in the food and drink can be strictly set, and in view of long-term storage ability, the liquid form is preferably used.

In the case where the target is soil, the growth of heat-resistant mold in the soil can be inhibited by adding the heat-resistant mold growth inhibitor to the soil. The heat-resistant mold growth inhibitor is added to the soil such that the concentration of diethyl fumarate and/or 2-decenoic acid is preferably 1 to 40000 ppm, more preferably 10 to 20000 ppm, still more preferably 20 to 10000 ppm, and further preferably 30 to 5000 ppm.

Further, the heat-resistant mold growth inhibitor is added to the soil such that the concentration of diethyl fumarate is preferably 1 to 20000 ppm, more preferably 10 to 20000 ppm, still more preferably 20 to 5000 ppm, and further preferably 30 to 2500 ppm.

Furthermore, the heat-resistant mold growth inhibitor is added to the soil such that the concentration of 2-decenoic acid is preferably 1 to 20000 ppm, more preferably 10 to 10000 ppm, still more preferably 20 to 5000 ppm, and further preferably 30 to 2500 ppm.

The heat-resistant mold growth inhibitor may be added to the soil as it is, or as necessary, the soil and the heat-resistant mold growth inhibitor may be mixed. Alternatively, for example, the heat-resistant mold growth inhibitor may be dissolved in a solvent such as ethanol to prepare a solution, and then the solution may be added to the soil, or powder prepared by mixing the heat-resistant mold growth inhibitor with an excipient (e.g., gum arabic or dextrin) and the like may be added to the soil.

In the case where the target is floor, wall, or house dust, the growth of heat-resistant mold on the floor or the like can be inhibited by, for example, spraying or applying the heat-resistant mold growth inhibitor to the floor or the like. The heat-resistant mold growth inhibitor may be directly dispersed on the floor or the like as powder. Alternatively, it is preferable to prepare a solution by dissolving the heat-resistant mold growth inhibitor in a solvent such as ethanol, and then the solution is sprayed or applied. In particular, it is preferable to prepare a solution having the concentration of diethyl fumarate and/or 2-decenoic acid in the range of 1 to 40000 ppm, more preferably 10 to 20000 ppm, still more preferably 20 to 10000 ppm, and further preferably 30 to 5000 ppm. An amount of the solution sprayed or applied is preferably such that the solution is spread over the floor or the like. As a standard, the amount is 200 g/m², although it depends on the surface state of the floor or the like.

Further, the solution of the heat-resistant mold growth inhibitor preferably contains diethyl fumarate at a concentration of 1 to 20000 ppm, more preferably 10 to 10000 ppm, still more preferably 20 to 5000 ppm, and further preferably 30 to 2500 ppm.

Furthermore, the solution of the heat-resistant mold growth inhibitor preferably contains 2-decenoic acid at a concentration of 1 to 20000 ppm, more preferably 10 to 10000 ppm, still more preferably 20 to 5000 ppm, and further preferably 30 to 2500 ppm.

Food and Drink in which Growth of Heat-Resistant Mold is Inhibited

The food and drink in which the growth of heat-resistant mold is inhibited according to the present embodiment is added with the heat-resistant mold growth inhibitor such that the concentration of diethyl fumarate and/or 2-decenoic acid is 1 to 40000 ppm, more preferably 10 to 20000 ppm, still more preferably 20 to 10000 ppm, and further preferably 30 to 5000 ppm.

An amount of the heat-resistant mold growth inhibitor added to the food and drink is such that the concentration of diethyl fumarate in the food and drink is preferably 1 to 20000 ppm, more preferably 10 to 10000 ppm, still more preferably 20 to 5000 ppm, and further preferably 30 to 2500 ppm.

Further, an amount of the heat-resistant mold growth inhibitor added to the food and drink is such that the concentration of 2-decenoic acid in the food and drink is preferably 1 to 20000 ppm, more preferably 10 to 10000 ppm, still more preferably 20 to 5000 ppm, and further preferably 30 to 2500 ppm.

The form and production of the food and drink are as described above in the section “Method for Inhibiting Growth of Heat-resistant Mold,” and thus the description thereof is emitted.

### EXAMPLES

Hereinafter, the embodiments of the present disclosure will be described specifically by way of Examples. However, the present disclosure is by no means limited by the following Examples.

### Examples 1 to 4, and Comparative Example 1: Growth of B. fulva

Diethyl fumarate or 2-decenoic acid was added to tomato juice (100% pure, salt-free) such that the concentration of the component was as shown in Table 1 below. Then, the juices were left to stand under a 25° C. atmosphere, and it was examined whether the growth of B. fulva was observed in the tomato juices after a lapse of predetermined days. The results are also shown in Table 1 below.

In Table 1, those showing the growth of B. fulva are represented by “+,” and those showing no growth are represented by “−.”

TABLE 1
[Growth of B. fulva]

| | | | Number of days elapsed under storage at 25° C. | | | | |
|---|---|---|---|---|---|---|---|
| | Active | Concentration | 3 | 5 | 7 | 10 | 14 |
| | component | (ppm) | days | days | days | days | days |
| Comparative | None | — | − | + | + | + | + |
| Example 1 | | | | | | | |
| Example 1 | Diethyl | 70 | − | − | − | + | + |
| Example 2 | fumarate | 270 | − | − | − | − | − |
| Example 3 | 2-Decenoic | 70 | − | − | − | + | + |
| Example 4 | acid | 270 | − | − | − | − | − |

From the results shown in Table 1, it is confirmed that Examples 1 to 4 exhibit the growth inhibition effect against B. fulva, which is heat-resistant mold. In particular, Examples 2 and 4 each having high concentration of the active component show no generation of B. fulva even after the lapse of 14 days, thus demonstrating that the growth inhibition effect is maintained. On the other hand, Comparative Example 1 in which none of these active components is added shows the generation of B. fulva after the lapse of 5 days.

### Examples 5 to 8, and Comparative Example 2: Growth of N. primulina

Diethyl fumarate or 2-decenoic acid was added to tomato juice (100% pure, salt-free) such that the concentration of the component was as shown in Table 2 below. Then, the juices were left to stand under a 25° C. atmosphere, and it was examined whether the growth of N. primulina was observed in the tomato juices after a lapse of predetermined days. The results are also shown in Table 2 below.

In Table 2, those showing the growth of N. primulina are represented by “+,” and those showing no growth are represented by “−.”

TABLE 2
[Growth of N. primulina]

| | | | Number of days elapsed under storage at 25° C. | | | | |
|---|---|---|---|---|---|---|---|
| | Active | Concentration | 3 | 5 | 7 | 10 | 14 |
| | component | (ppm) | days | days | days | days | days |
| Comparative | None | — | + | + | + | + | + |
| Example 2 | | | | | | | |
| Example 5 | Diethyl | 70 | − | − | − | − | + |
| Example 6 | fumarate | 270 | − | − | − | − | − |
| Example 7 | 2-Decenoic | 70 | − | + | + | + | + |
| Example 8 | acid | 270 | − | − | − | − | − |

From the results shown in Table 2, it is confirmed that Examples 5 to 8 exhibit the growth inhibition effect against N. primulina, which is heat-resistant mold. In particular, Examples 5 and 6 each containing diethyl fumarate as an active component show no generation of N. primulina even after the lapse of 10 days, thus demonstrating that the growth inhibition effect is maintained. Furthermore, Examples 6 and 8 each having high concentration of the active component show that the effect is maintained even after the lapse of 14 days. On the other hand, Comparative Example 2 in which none of these active components is added show the generation of N. primulina after the lapse of 3 days.

### Examples 9 and 10, and Comparative Examples 3 to 16

Diethyl fumarate and 2-decenoic acid were prepared for use in Examples. In addition, the following components reported to have a growth inhibition effect against normal mold (non-heat-resistant mold) were prepared for use in Comparative Examples: palmitic acid, trans-anethole, benzyl alcohol, cinnamic acid, hinokitiol, salicylic acid, hexanal, 2-mercapto benzothiazole, p-cymene, 1,8-cineole, α-pinene, estragole, 4-hydroxy-3,5-dimethoxybenzoic acid, and linalyl acetate. Then, each component was added to a medium of Trypticase soy broth such that the concentration of each component was as shown in Table 3 below.

These media were stored for 7 days under an atmosphere at 25° C. Then, it was examined whether the growth of N. primulina and/or B. fulva was observed in the media after the lapse of 7 days from the addition. The results are also shown in Table 3 below. In Table, those showing the growth are represented by “+,” and those showing no growth are represented by “−.”

TABLE 3

| | | After lapse of 7 days | |
|---|---|---|---|
| | Active component | under storage at 25° C. | |
| | (concentration 1000 ppm) | N. primulina | B. fulva |
| Example 9 | Diethyl fumarate | − | − |
| Example 10 | 2-Decenoic acid | − | − |
| Comparative | Palmitic acid | + | + |
| Example 3 | | | |
| Comparative | Trans-anethole | + | + |
| Example 4 | | | |
| Comparative | Benzyl alcohol | + | + |
| Example 5 | | | |
| Comparative | Cinnamic acid | + | + |
| Example 6 | | | |
| Comparative | Hinokitiol | + | + |
| Example 7 | | | |
| Comparative | Salicylic acid | + | + |
| Example 8 | | | |
| Comparative | Hexanal | + | + |
| Example 9 | | | |
| Comparative | 2-Mercapto benzothiazole | + | + |
| Example 10 | | | |
| Comparative | p-Cymene | + | + |
| Example 11 | | | |
| Comparative | 1,8-Cineole | + | + |
| Example 12 | | | |
| Comparative | α-Pinene | + | + |
| Example 13 | | | |
| Comparative | Estragole | + | + |
| Example 14 | | | |
| Comparative | 4-Hydroxy-3,5- | + | + |
| Example 15 | dimethoxybenzoic acid | | |
| Comparative | Linalyl acetate | + | + |
| Example 16 | | | |

The results in Table 3 show that Examples 9 and 10 exhibit the growth inhibition effect against both B. fulva and N. primulina, which are species of heat-resistant mold. Thus, it is found that the heat-resistant mold growth inhibitor containing diethyl fumarate or 2-decenoic acid as an active component is excellent.

On the other hand, none of Comparative Examples 3 to 16, which are thought to have the growth inhibition effect against normal mold, do not exhibit growth inhibition effect against heat-resistant mold. From this result, it is found that a component having the growth inhibition effect against normal mold does not necessarily have the growth inhibition effect against heat-resistant mold.

While specific forms of the present disclosure have been shown in the abovementioned Examples, the Examples are merely illustrative and not limitative of the present disclosure. It is contemplated that various modifications apparent to those skilled in the art could be made within the scope of the invention.

### INDUSTRIAL APPLICABILITY

The present disclosure is useful as a heat-resistant mold growth inhibitor capable of inhibiting the growth of heat-resistant mold without performing heat treatment at a high temperature.

1. A heat-resistant mold growth inhibitor comprising diethyl fumarate, 2-decenoic acid, or a combination of diethyl fumarate and 2-decenoic acid as an active component.

2. The heat-resistant mold growth inhibitor according to claim 1, wherein the heat-resistant mold survives under a heating condition at 70° C. for 10 minutes.

3. The heat-resistant mold growth inhibitor according to claim 1, wherein the heat-resistant mold belongs to at least one of the genus Byssochlamys or the genus Neosartorya.

4. A food or drink, comprising the heat-resistant mold growth inhibitor according to claim 1, wherein the diethyl fumarate, the 2-decenoic acid, or the combination of diethyl fumarate and 2-decenoic acid is at a concentration of 1 to 40000 ppm.

5. The food or drink in which growth of heat-resistant mold is inhibited according to claim 4, wherein the concentration of diethyl fumarate is 1 to 20000 ppm.

6. The food or drink in which growth of heat-resistant mold is inhibited according to claim 4, wherein the concentration of 2-decenoic acid is 1 to 20000 ppm.

7. A method for inhibiting growth of heat-resistant mold in a food or drink, the method comprising adding the heat-resistant mold growth inhibitor according to claim 1 to the food or drink, wherein the diethyl fumarate, the 2-decenoic acid, or the combination of diethyl fumarate and 2-decenoic acid is at a concentration of 1 to 40000 ppm.

8. The method for inhibiting growth of heat-resistant mold according to claim 7, wherein the heat-resistant mold growth inhibitor is added to the food or drink such that the concentration of diethyl fumarate is 1 to 20000 ppm.

9. The method for inhibiting growth of heat-resistant mold according to claim 7, wherein the heat-resistant mold growth inhibitor is added to the food or drink such that the concentration of 2-decenoic acid is 1 to 20000 ppm.

10. A method for inhibiting growth of heat-resistant mold in a target, comprising using the heat-resistant mold growth inhibitor according to claim 1.
